(19) United States
(12) Patent Application Publication
(10) Pub. No.: US 2025/0283371 A1
(43) Pub. Date: Sep. 11, 2025

(54) Fire Resistant Insulated Glass Structures

(71) Applicant: O'KEEFFE'S, INC., BRISBANE, CA (US)

(72) Inventor: William F O'Keefe, Brisbane, CA (US)

(73) Assignee: O'KEEFFE'S, INC., BRISBANE, CA (US)

(21) Appl. No.: 18/104,751

(22) Filed: Feb. 1, 2023

Related U.S. Application Data
(60) Provisional application No. 63/305,992, filed on Feb. 2, 2022.

(51) Int. Cl. E06B 3/67; E06B 3/66

(52) U.S. Cl. CPC E06B 3/6715; E06B 3/6612

(57) ABSTRACT

A fire-resistant or fire-rated thermal glass unit that utilizes a thermal insulating glass component mated to a fire-resistant or fire-rated glass component, such as in a side-by-side relationship. An integrated unit is formed including, in some cases, a sealed chamber between the vacuum glass component and the fire-rated glass component that may be filled with air, an insulating gas, or that is structured to maintain a vacuum therewithin. In other instances, fire resistant materials may be used to fill the sealed chamber. The integrated unit can be installed in buildings and other desired locations to provide the benefits of both fire resistance and thermal insulation using a single unit.

### CROSS-REFERENCES TO RELATED APPLICATIONS

This application claims the benefit of U.S. Provisional Patent Application Ser. No. 63/305,992 filed on Feb. 2, 2022, incorporated herein by reference.

### BACKGROUND

Vacuum glass or insulating glass structures generally consist of two or three glass panes separated by one or two sealed chambers filled with a vacuum or an insulating gas in order to reduce heat transfer across the same. Typically, insulating glass structures are formed with a thickness of prior known standard glass panes to accommodate frame members and the like.

Insulating glass structures have also achieved much improved thermal performance, usually expressed as heat insulating properties. The effectiveness of an insulated glass structures is usually expressed as an R-value. In other words, the higher the R-value, the greater the insulating unit's resistance is to heat transfer. For example, a typical double 15 pane standard insulating glass unit possesses an R-value unit of about 0.5 K·m2/w. Using argon glass between a pair of glass panes of an insulated glass unit increases the efficiency of such structure to a value of R-3. Triple glazed insulated glass structures with low emissivity coatings on the glass pane 20 surfaces and filled with argon gas in the cavity between the panes results in an R-value as high as R-5. Establishing a vacuum between the panes of the insulated glass unit may establish in an R-value as high as 12.5. It should also be noted that insulated glass structures also provide a high degree of acoustic insulation.

Although providing superior heat insulation and acoustic attenuation properties, such insulated glass structures are not fire-rated. A fire-rated thermal glass unit would be a notable advance in the glazing arts.

### SUMMARY

Provided are a plurality of example embodiments of a fire-resistant, thermal insulating window system, including, but not limited to, a fire-resistant glass structure having insulating features, comprising: a fire-resistant glass portion configured to provide fire resistant properties to the structure; and an insulating portion configured with said fire-resistant portion to form an integrated structure, said insulating portion being configured to improve the thermal insulation of the structure above the insulation provided by the fire-rated glass portion alone.

Also provided is a fire-rated glass structure having insulating features, comprising: a fire-rated glass portion including at least one pane of fire-rated glass configured to provide fire resistant properties to the structure; an insulating portion including a sealed chamber filled with an insulating gas or provided with a vacuum, wherein said insulating portion is configured with said fire-rated portion to form an integrated structure, said insulating portion being configured to improve the thermal insulation of the structure above the insulation provided by the fire-rated glass portion alone.

Still further provided is a fire-rated glass structure having insulating features, comprising: a fire-rated glass portion including at least one pane of fire-rated glass configured to provide fire resistant properties to the structure; and an insulating portion including at least one other pane of glass configured to form a sealed chamber filled with an insulating gas or provided with a vacuum, wherein said insulating portion is configured with said fire-rated portion to form an integrated structure, said insulating portion being configured to improve the thermal insulation of the structure above the insulation provided by the fire-rated glass portion alone.

Also provided is a method of insulating and providing fire resistance to a desired location using any of the structures disclosed herein.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1A is a sectional view of an example fire-rated vacuum glass unit of the present application with the fire resistant and thermal insulating portions depicted schematically.

FIG. 1B is a sectional view of another example fire-resistant vacuum glass unit of the present application with the fire resistant and thermal insulating portions depicted schematically.

FIG. 1 is a sectional view of another example of the fire-resistant vacuum glass unit of the present application with the fire glass portion depicted schematically.

FIG. 2 is a sectional view of a first embodiment of the fire-resistant vacuum glass unit.

FIG. 3 is a sectional view of a second embodiment of the fire-resistant glass portion of the fire-resistant vacuum glass unit.

FIG. 4 is a sectional view a third embodiment of the fire-resistant glass portion of the fire-resistant vacuum glass unit.

FIG. 5 is a sectional view of a fourth embodiment of the fire-resistant glass portion of the fire-resistant vacuum glass unit.

FIG. 6 is a sectional view of a fifth embodiment of the fire-resistant glass portion of the fire-resistant vacuum glass unit.

FIG. 7 is a sectional view of sixth embodiment of the fire-resistant glass portion of the fire-resistant vacuum glass unit.

FIG. 8 is a sectional view of a seventh embodiment of the fire-resistant glass portion of the fire-resistant vacuum glass unit.

FIG. 9 is a sectional view of an eighth embodiment of the fire-resistant glass portion of the fire-resistant vacuum glass unit.

FIG. 10 is a sectional view of a ninth embodiment of the fire-resistant glass portion of the fire-resistant vacuum glass unit.

### DETAILED DESCRIPTION OF THE EXAMPLE EMBODIMENTS

In accordance with the present application, a novel and useful fire-resistant thermal glass unit is herein provided.

The fire-resistant thermal glass unit of the present application (which may be fire rated by testing to desired certification standards) utilizes a thermal insulating glass component which is mated to a fire-rated glass component, such as in a side-by-side relationship. An integrated unit is formed including, in some embodiments, a sealed chamber between the vacuum glass component and the fire-rated glass component that is formed using a spacer. The spacer may take the form of a rigid or semi-rigid member that is maintained in place between the thermal glass unit and the fire-rated glass unit. In addition, a sealant may be used in conjunction with the spacer to further isolate the chamber lying between the vacuum glass component and the fire-rated glass component. In certain instances, the chamber may be filled with air, an inert gas, or structured to maintain a vacuum therewithin. In other instances, fire resistant materials may be used to fill the chamber.

The fire-resistant glass component may take the form of multiple glass panes separated from one another to form a space or spaces (e.g., sealed or unsealed chamber(s)) therebetween. Such space or spaces may be filled with a resin or gel-like polymeric fire retardant material. In certain instances, more than two panes may be used to form multiple spaces therebetween, each filled with the resin or gel-like polymeric fire retardant material. Moreover, the fire resistant (or fire rated) glass component of the fire-resistant glass component may take the form of a fire-rated thick specially tempered thick glass. Further, such specially tempered thick glass may be constructed of a multiplicity of panes that are laminated to one another to achieve the desired thickness and fire-rating qualities. Also, the fire-resistant glass component may utilize other fire-rated glass elements, such as ones formed of laminated or filmed ceramic material. Alternatively, these chamber(s) between the fire resistant panes may be filled with insulating gas or provided with a vacuum to make the resulting unit more thermally insulating.

It may be apparent that a novel and useful fire-resistant thermal glass unit has been hereinabove described. One or more of the disclosed embodiments can provide a fire-rated glass unit that exhibits superior thermal insulation qualities and possesses a measurable fire rating characteristic. They can also provide a fire-rated thermal glass unit that is extremely thin compared to the prior art multi-pane glass units. They can also provide a fire-resistant thermal glass unit that possesses an extremely low sound transmission class rating.

One or more such embodiments can be provided more compact than prior art fire-rated multi-pane glass units, and may provide a fire-resistant thermal glass unit which may be used with both fire-protective and fire-resistant glazing components. They can provide a fire-resistant thermal glass unit which is relatively simple to manufacture and exhibits a high degree of durability. They can also provide a fire-resistant thermal glass unit that affords a high degree of light transmission compared to prior art glass units. Various embodiments of the invention possess other benefits and advantages especially as concerns particular characteristics and features thereof which will become apparent herein, in particular in reference to the various figures showing example embodiments therefor.

Various aspects of the present application will evolve from the following detailed description of the preferred embodiments thereof which should be referenced to the prior described drawings.

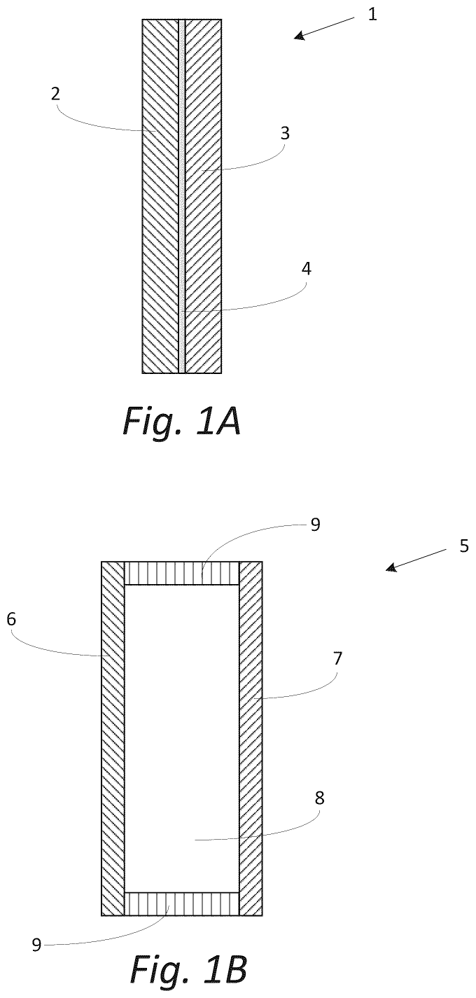

FIG. 1A shows a cross-section of a simple generic example embodiment 1 where a fire-resistant glass component 2 is placed adjacent to a thermal insulating glass component 3 with, if desired, some intermediate structure 4 provided between them. The intermediate structure 4 may be a structural component, such as glue, resin, gaskets, or some other material to connected fire-resistant component 2 to thermal insulation component 3 to form an integrated structure that can installed as a window, wall, door, or other structure in a building to provide both fire resistance and thermal insulation benefits.

The fire-resistant glass component 2 can be any fire resistant glass system known in the art, such as a fire rated window pane with any additional structural components needed to make the integrated structure 1 fire resistant as a unit. Similarly, the thermal insulating glass component 3 can be any thermal insulating glass system known in the art, such as a thermal window pane (which may utilize multiple individual window panes with thermal insulation features) with any additional structural components needed to make the integrated structure 1 provide effective thermal insulation as a unit.

FIG. 1B shows a cross section of another simple generic example embodiment 5 where a fire-resistant glass component 6 is placed adjacent to a thermal insulating glass component 7 utilizing spacing structures 9 to form a sealed chamber 8 between them. Spacing structures 9 may include spacers and/or sealants be provided around an entire perimeter of the system 5 to ensure full sealing of the chamber 8 from the outside environment.

This example embodiment 5 can be constructed of any fire resistant or fire rated glass system known in the art, such as a fire rated window panel with any additional structural components needed to make the integrated structure 6 fire resistant as a unit. Similarly, the thermal insulating glass component 7 can be any thermal insulating glass system known in the art, such as a thermal window pane (which may utilize multiple individual window panes with thermal insulation features) with any additional structural components needed to make the integrated structure 5 provide effective thermal insulation as a unit.

The sealed chamber 8 can be utilized to provide additional fire resistance, and/or additional thermal insulation, by filling the chamber with one or more substances useful therefor. For example, sealed chamber 8 can be filled with an insulating gas, or provided with a vacuum, to improve the insulating properties of the overall system 5. Alternatively, the sealed chamber 8 could be filled with a fire resistant material, such as a fire resistant resin, gel, liquid, gas, or other substance. Alternatively, the sealed chamber 8 might be filled with a substance that can provide both fire resistance and thermal insulation improvements to the integrated system 5.

Alternatively, the integrated system 5 might utilize a pair of fire-resistant systems for both components 6 and 7, and then utilize the sealed chamber 8 to provide thermal insulation, such as by filling the chamber 8 with an insulating gas, or providing a vacuum.

With reference to FIG. 1, it may be observed that fire-resistant thermal glass unit 10 is shown. The fire-resistant thermal glass unit is formed by the mating of a conventional insulated glass component 12 (e.g., a vacuum glass component) and a fire-rated glass component 14. The latter is depicted in a schematic format since many types of fire-rated glass components may be employed with insulated glass component 12. In any case, insulated glass component 12 includes glass panes 16 and 18 separated by a spacer 20 or warm edge 20 to form a sealed gas space 22 between panes 16 and 18. Gas space 22 may be filled with an inert gas such as argon, krypton, xenon, and the like. In addition, gas space 22 may be constructed to hold formed a vacuum. Fire-rated glass component 14 is separated from insulated glass component 12 by a spacer 24 to form a sealed chamber 26. Chamber 26 may be filled with air, an inert gas, a fire-resistant gel or resin, or be contain a vacuum.

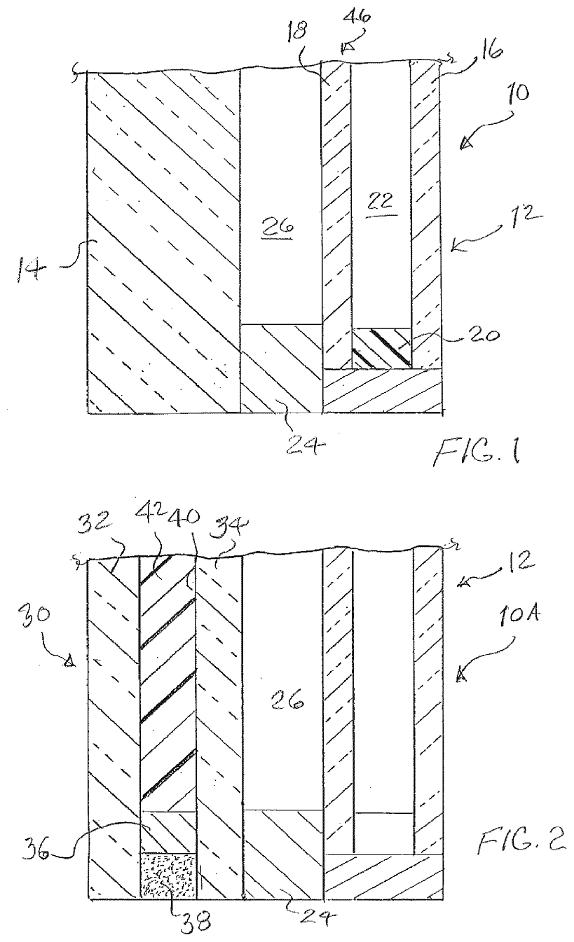

Turning to FIG. 2, it may be seen that embodiment 10A of the fire-resistant thermal glass unit is shown. Unit 10A includes the insulated glass component 12 and a fire-rated glass component 30. Fire-rated glass component 30 is intended to fulfil or serve as fire-rated glass component 14 of FIG. 1. Subsequently described fire-resistant glass components in FIGS. 3-9 perform the same function. Fire-rated glass component 30 includes glass panes 32 and 34 separated by a spacer 36. A sealant 38 isolates glass panes 32 and 34 from one another to form a chamber 40. Chamber 40 is filled with a material 42 such as a resin or a gel-like polymeric material such as polyvinylbutyral (PVB), polyethylene terephthalate (PET), and the like. It should be noted that material 42 is a fire-resistant infill known in the art. Fire-rated component 30 may take the form of a fire-rated glazing unit sold as 60 Minute SL-II-XL.

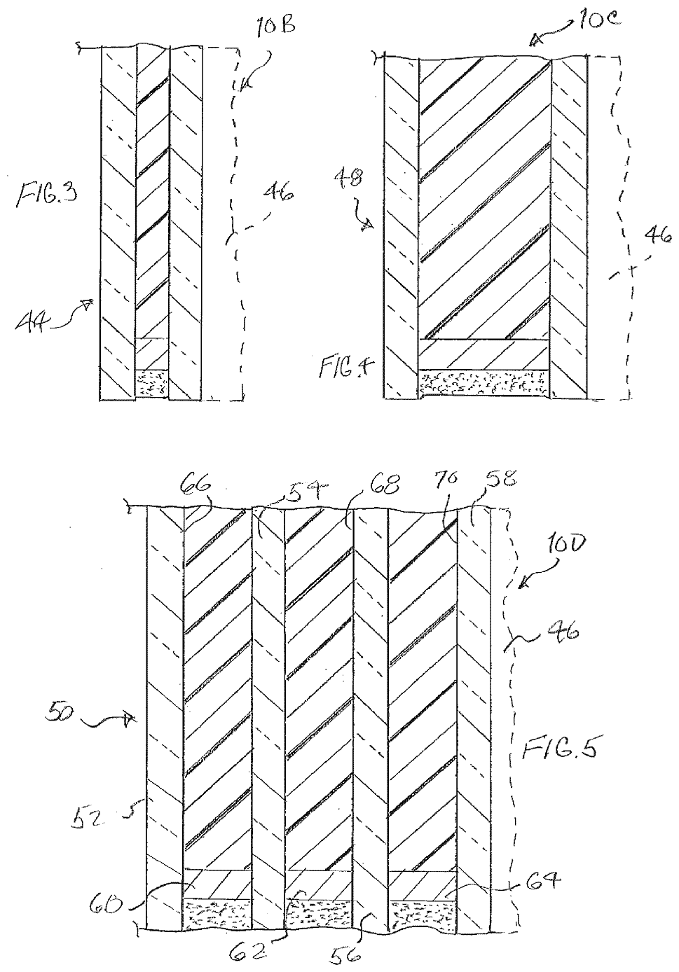

FIG. 3 depicts another embodiment 10B in which a fire-rated glass component 44 serves as the schematically depicted fire-rated glass component 14 of FIG. 1. Fire-rated glass component 44 is similar in structure to fire-rated glass component 30 of FIG. 2, but has a lesser fire rating than fire-rated glass component 30 of FIG. 2. Fire-rated glass component may be one sold as 45 Minute SL-II-XL. The remaining portions of fire-rated glass unit 10B, including spacer 24 and insulated glass component 12, is depicted in phantom by reference character 46 and is depicted similarly in FIGS. 4-9, which will be discussed hereinafter.

FIG. 4 shows embodiment 10C of the present application in which fire-rated glass component 48 is employed as schematically delineated fire-rated glass component 14 of FIG. 1. Fire-rated glass component 48 is similar to fire-rated glass components 30 and 44 except that it possesses a higher fire rating. It may take the form of a 90/120 Minute SL-II-XL product.

With reference to FIG. 5, it may be observed that another embodiment 10D of the present application is depicted. Embodiment 10D utilizes a fire-rated glass component 50 as the schematically shown fire-rated glass component 14 of FIG. 1. Fire-rated glass component 50 may take the form of a product 60/120 SL-II-XLB product. As shown in FIG. 5, fire-rated glass component 50 utilizes glass panes 52, 54, 56, and 58 separated by plugs 60, 62, and 64. Again, chambers 66, 68, and 70 are filled with a fire-resistant filler material similar to that used with respect to chamber 40 of FIG. 2.

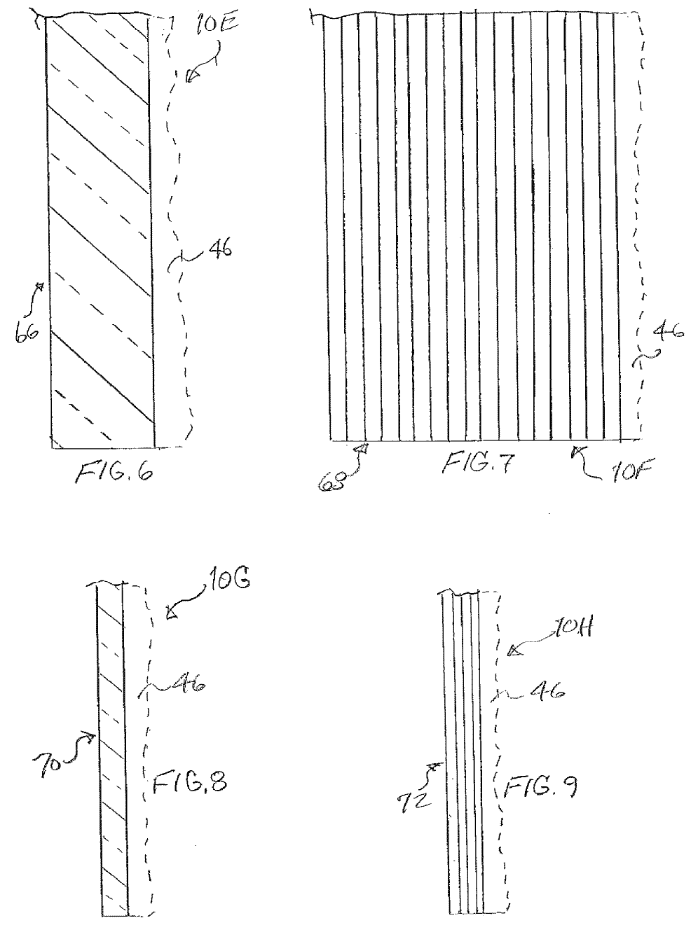

FIG. 6 depicts embodiment 10E of the fire-rated thermal glass unit of the present application. Fire-rated glass component 66 comprises a solid thick piece of glass that is available as a product known as X-45/60/90 Super Clear, such as disclosed in U.S. Pat. No. 11,479,504 issued on Oct. 25, 2022, and incorporated herein by reference in its entirety.

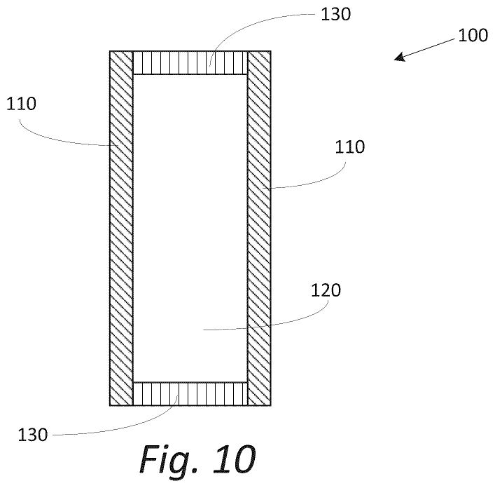

FIG. 10 shows an example embodiment utilizing a pair of Super Clear fire-rated glass components 110 with spacers 130 to form a sealed chamber 120 which can be filled with an insulating gas or hold a vacuum to provide thermal insulation for the system 100, thereby providing a fire-rated system with thermal insulation capability with all of the advantages of the Super Clear innovations.

FIG. 7 illustrates embodiment 10F of the present application in which the fire-rated glass component 68 is employed as schematically rendered fire-rated glass component 14 of FIG. 1. Fire-rated glass component 68 may take the form of a product sold as 120 Minute SL-II-XLM. As shown, fire-rated glass component 68 is a multi-laminated glass structure.

FIG. 8 reveals yet another embodiment 10G of the fire-rated glass unit 10 of the present application. Fire-rated glass component 70 is fashioned as a filmed ceramic material.

FIG. 9 shows embodiment 10H of the fire-rated thermal glass unit of the present application in which the fire-rated glass component 72 takes the form of a laminated ceramic element. Fire-rated glass components 30, 44, 48, 50, 66, 68, 70, and 72 are available and distributed by SaftiFirst of Brisbane, California.

Note that the above described embodiments can be utilized wherever thermal insulation window designs that are desired, while adding the additional features of fire resistance and even a fire rating certification. In addition, these embodiments can provide thermal insulation where currently fire resistant systems are used without such capability. Examples of such use include in doors, as walls and dividers, floors, for exterior or interior windows, etc. They can be used wherever the combination of fire resistance and thermal insulation are desired in a transparent window, or even for structural components.

For the embodiments utilizing sealed vacuum chambers, various means in the art of effectively sealing such chambers to hold the vacuum long-term can be utilized. For example, a process known as Vacuum Insulated Glazing can be used. Seals utilizing lead-based solder and other sealing mechanisms can be utilized, as can any state-of-the-art sealing techniques.

The fire resistant thermal glass unit can then be tested and certified to various standards. For example, for fire resistance testing, the product can be tested to fire testing standards NFPA 251, NFPA 252, NFPA 257, UL263, UL 9, UL 10c, and UL 10b with and without the hose stream applied to meet or exceed the requirements. In this matter, the unit can be fire rated after passing such tests according to these various standards, among others.

For thermal testing, the units can be tested to the National Fenestration Rating Council's (NFRC) requirements NFRC 100, 101, 102, 200, 201, 202, 203, and 500 which also would include the standard testing methods in AAMA 507, 1503, 1506, and ASTM C518, C1199, C1289, C1363, E2264, and CAN/ULC S770, and CSA A440.2. The thermal testing standards include thermal transmission (U-Factor), thermal resistance (R-Factor), thermal conductivity (k-value), solar heat gain coefficient (SHGC), visible transmittance (VT, VTL), condensation resistance (CRF), and temperature cycling accelerating the unit's weathering/ageing in extreme conditions”. In this manner, the units can be thermally rated according to these various standards, among others.

Testing to the ASTM E2190 standard can also be utilized, which is a standard to ensure that the gas filled chambers are maintained and the perimeter seal is sealed sufficiently to keep moisture out of the cavity. The test runs in extreme temperatures (hot and cold) with high humidity for about 15 to 16 weeks with periodical checks on the amount of gas still within the cavity/chamber along with any frost or moisture visible in the inside of the cavity/chamber.

The completed units having fire resistant, insulation properties can then be installed into buildings such as in window frames, doors, walls, floors, and other structures, as desired, in any proper manner known in the art for installing fire-rated windows and/or insulated windows. Where necessary, the structure might be modified to add additional structural components and/or strength to support the larger and/or heavier units than might be typically used for standard insulated and/or fire rated windows.

Many other example embodiments can be provided through various combinations of the herein described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A fire-resistant glass structure having insulating features, comprising:
a fire-resistant glass portion configured to provide fire resistant properties to the structure; and
an insulating portion configured with said fire-resistant portion to form an integrated structure, said insulating portion being configured to improve the thermal insulation of the structure above the insulation provided by the fire-resistant glass portion alone.

2. The glass structure of claim 1, wherein said insulating portion is comprised of:
a first pane of glass;
a second pane of glass arranged adjacent to said first pane of glass with a sealed chamber between them, wherein
said sealed chamber is filled with an insulating gas or provided with a vacuum.

3. The glass structure of claim 2, wherein said fire resistant glass portion is comprised of a pane of fire rated glass that is placed adjacent to the insulating portion.

4. The glass structure of claim 2, wherein said fire resistant glass portion is comprised of a pane of fire rated glass that is placed adjacent to the insulating portion with a second sealed chamber provided between said fire resistant glass portion and said insulating portion, wherein said second sealed chamber is filled with an insulating material, a fire resistant material, or is provided with a vacuum.

5. The glass structure of claim 4, wherein said first sealed chamber is formed by separating said first pane of glass from said second pane of glass using a spacer.

6. The glass structure of claim 5, wherein said second sealed chamber is formed by separating said fire rated pane of glass from said insulating portion using another spacer.

7. The glass structure of claim 4, wherein said first sealed chamber is provided with a vacuum.

8. The glass structure of claim 4, wherein said second sealed chamber is filled with an insulating material including an insulating gas.

9. The glass structure of claim 4, wherein said second sealed chamber is filled with a fire resistant material including a fire resistant resin or gel.

10. The glass structure of claim 1, wherein said fire resistant glass portion is comprised of a pane of fire rated glass that is placed adjacent to the insulating portion.

11. The glass structure of claim 1, wherein said fire resistant glass portion is comprised of a pane of fire rated glass that is placed adjacent to the insulating portion with a sealed chamber provided between said fire resistant glass portion and said insulating portion, wherein said sealed chamber is filled with an insulating gas or provided with a vacuum.

12. The glass structure of claim 11, wherein said first sealed chamber is provided with a vacuum.

13. The glass structure of claim 1, wherein said fire resistant glass portion is comprised of a first pane of fire rated glass arranged with a second pane of glass to form a sealed chamber between said panes, said sealed chamber being filled with an insulating gas or provided with a vacuum.

14. The f structure of claim 13, wherein said second pane of glass is also fire rated.

15. The glass structure of claim 1, wherein said fire resistant glass portion is comprised of a laminated structure including at least one pane of glass laminated with a polymer film layer.

16. The glass structure of claim 1, wherein said fire resistant glass portion is comprised of a ceramic material.

17. The glass structure of claim 1, wherein said fire resistant glass portion used fire rated glass that is rated to one or more of NFPA 251, NFPA 252, NFPA 257, UL263,UL 9, UL 10c, and/or UL 10b.

18. A fire-resistant glass structure having insulating features, comprising:
a fire-rated glass portion including at least one pane of fire-rated glass configured to provide fire resistant properties to the structure;
an insulating portion including a sealed chamber filled with an insulating gas or provided with a vacuum, wherein
said insulating portion is configured with said fire-rated portion to form an integrated structure, said insulating portion being configured to improve the thermal insulation of the structure above the insulation provided by the fire-rated glass portion alone.

19. A fire-resistant glass structure having insulating features, comprising:
a fire-rated glass portion including at least one pane of fire-rated glass configured to provide fire resistant properties to the structure; and
an insulating portion including at least one other pane of glass configured to form a sealed chamber filled with an insulating gas or provided with a vacuum, wherein
said insulating portion is configured with said fire-rated portion to form an integrated structure, said insulating portion being configured to improve the thermal insulation of the structure above the insulation provided by the fire-rated glass portion alone.

20. The glass structure of claim 19, wherein said insulating portion includes still another pane of glass formed with the one other pane of glass to form said sealed chamber.

21. The glass structure of claim 19, wherein said insulating portion includes still another pane of glass formed with the one other pane of glass to form said chamber, and wherein said fire rated pane of glass is configured with said one other pane of glass to form another sealed chamber filled with a fire resistant material, an insulating gas, or provided with a vacuum.
